(19) United States
(12) Patent Application Publication
(10) Pub. No.: US 2010/0283851 A1
(43) Pub. Date: Nov. 11, 2010

(54) SYSTEM AND METHOD FOR MULTI-SIGNAL SWITCHINGING IN A SURVEILLANCE SYSTEM

(75) Inventors: Dehui ZHAO, Shenzhen City (CN); Jun PENG, Shenzhen City (CN); Li LIU, Shenzhen City (CN); Ruihong PEI, Shenzhen City (CN); Haitang CAO, Shenzhen City (CN)

Correspondence Address: SHENZHEN INFINOVA LIMITED;6/F, H-3, EAST INDUSTRIAL ZONE, OVERSEAS CHINESE TOWN, NANSHAN DISTRICT, SHENZHEN CITY, CN

(73) Assignee: SHENZHEN INFINOVA LIMITED, SHENZHEN CITY (CN)

(21) Appl. No.: 12/437,566

(22) Filed: May 8, 2009

(51) Int. Cl. H04N 9/47

(52) U.S. Cl. 348/143

(57) ABSTRACT

The present invention discloses a type of universal signal switching system and method for security surveillance systems, and the method includes the following steps: A. The signal receiving/transmitting units pack the acquired multiform signals and transmits them to the TSI-SDS-TSI switching unit; B. The TSI-SDS-TSI switching unit conducts decomposition of the received multiform signals, and conduct TSI-SDS-TSI switching of the decomposed signals. As the invention adopts the TSI-SDS-TSI switching method to implement the switching of multiform signals by different signal receiving/transmitting units, the system is high integrated, the number of equipments and interfaces in the system can be reduced, and the system reliability and expandability can be improved.

### BACKGROUND OF THE INVENTION

This invention relates to the security surveillance field, and specifically to a system and method for multi-signal switching in a surveillance system.

A security surveillance system is an independent and integrated system composed of shooting equipment, image display equipment, and recording equipment. Audio and visual signals are transmitted in its closed loop through optic fibers, coaxial cables, or microwave. The existing security surveillance systems are mainly composed of front end section, transmission section, control section, and terminal section. The front end section performs signal acquisition, such as camera and audio acquiring equipment etc. The terminal section receives and displays signals acquired by the front end section, such as display screen and TV wall.

There are various types of front end equipments in the existing security surveillance systems, and they acquires more signals in use, mainly include video, audio, data, and alarm signals. These signals reach corresponding terminal section through transmission equipment. Generally speaking, the number of terminal equipments is much smaller than that of the front end equipments, therefore one terminal equipment has to correspond to multiple front end equipment. Consequently, access equipments are required to form an access layer to receive the signals from the front end equipment, enable the terminal equipments to receive the signals from multiple front end equipments in time-sharing mode or enable the control equipments to control multiple front end equipments in time-sharing mode by switching.

At present, both signal receiving from multiple front-end equipments and front-end equipments control are realized by superimposed access of different types of signals, like audio matrix switching system, video matrix switching system, and alarm device etc. One access equipment can only receive and switch one type of signals. For example, an audio matrix switching system can receive and switching audio signals only, a video matrix switching system can receive and switching video signals only. When the access layer requires more and more access equipments to process various signals, this method shows a lot of shortcomings. For example, cannot meet user's demands, cannot optimize the utilization of bandwidth, requiring more maintenance personnel, complicated network, requiring more special management platforms, higher operation cost, and relatively higher overall costs.

### BRIEF SUMMARY OF THE INVENTION

To solve the problem that the existing security surveillance systems cannot implement integrated switching of multi-signals, the invention provides a type of switching system and method for multi-signals in a surveillance system by configuring the signal receiving/transmitting devices and applying the TSI-SDS-TSI switching principle such that the audio, video, electric, optic, network, wireless, and satellite signals may be switching in integrated mode.

For the above-mentioned objective, the following technical solutions are mainly applied in the invention:

A type of multi-signal switching system in a surveillance system, including a CPU system unit, and the following are also included:

Signal receiving/transmitting units, used to receive the acquired multi-signals, pack and transmit the multi-signals to the TSI-SDS-TSI switching unit;

A TSI-SDS-TSI switching unit, used to decompose the multi-signal come from the signal receiving/transmitting units, and conduct TSI-SDS-TSI switching of the decomposed signals as per control of the CPU unit.

As per the optimization method, the said TSI-SDS-TSI switching unit is composed of:
A serial/parallel modular converter, used to convert the multi-signals come from the signal receiving/transmitting units into parallel signals and transmit them to the switching interface module;
A switching interface module, used to decompose the above-mentioned parallel signals into multiple simple info signals and corresponding status information;
A switching module, used to receive the multiple simple info signals come from the switching interface module, and conduct TSI-SDS-TSI switching of the info signals;
A control module, used to receive the control signals of CPU system unit, and configure the time-slot for the switching module as per the said control signals.

As per the optimization method, the said switching interface module transmits the decomposed status information to the CPU system unit, and the CPU system unit outputs the control signals to the control module according to the said status information.

As per the optimization method, the said switching module includes an input-stage switching module, an intermediate-stage switching module, and an output-stage switching module, and the said input-stage switching module, intermediate-stage switching module, and output-stage switching module conduct multiple info signal switching according to the time-slot configuration of the control module.

As per the optimization method, the said signal receiving/transmitting unit also includes a signal receiving/transmitting module and a signal processing module, the said signal processing unit may be also used to receive the signals that experienced the TSI-SDS-TSI switching, and unpack and output the information through the signal receiving/transmitting module.

The invention also provides a type of multi-signal switching method for security surveillance systems, and the steps include:

A. The signal receiving/transmitting units pack the acquired multi-signals and transmits them to the TSI-SDS-TSI switching unit;

B. The TSI-SDS-TSI switching unit conducts decomposition of the received multi-signals, and conduct TSI-SDS-TSI switching of the decomposed information.

As per the optimization method, a TSI-SDS-TSI switching unit is composed of a serial/parallel modular converter, a switching interface module, a switching module, and a control module, and the step B includes the following steps in detail:

b1. A serial/parallel modular converter converts the acquired multi-signals into parallel signals and transmits them to the switching interface module;

b2. A switching interface module decomposes the received parallel signals to generate multiple simple info signals and corresponding status information;

b3. The switching module conducts TSI-SDS-TSI switching of multiple simple info signals as per the time-slot configuration.

As per the optimization method, step b2 still includes the following substeps:

1) The switching interface module transmits the decomposed status information to the CPU system unit;

2) The CPU system unit transmits control signals to the control module as per the above-mentioned status information;

3) The control module conduct time-slot configuration of the switching module as per the control signals.

As per the optimization method, the steps next to step B are given below:

C. Compound the signals that had experienced the TSI-SDS-TSI switching with the control information transmitted by the CPU system unit to generate composite signals.

As per the optimization method, the steps next to step C are given below:

D. Utilize the serial/parallel modular converter to convert the compounded signals into serial signals, transmit the signals to the signal receiving/transmitting units, and allow the signals to be unpacked by the signal receiving/transmitting units before being output.

Compared with the existing technologies, the invention adopts a TSI-SDS-TSI switching unit that can decompose the multiple composite signals come from different signal receiving/transmitting units into multiple simple info signals and relevant status information, feed back the relevant status information to the CPU system unit. The CPU system unit conduct analysis the status information and generate corresponding control signals. The whole switching process of the invention is completed by the TSI-SDS-TSI switching unit with larger system capacity and less time delay. The switching of multi-signals from different signal receiving/transmitting units is implemented such that the system integration level may be greatly enhanced, the number of equipment and interfaces in the system may be reduced and the system reliability and expandability may be improved.

### BRIEF DESCRIPTION OF THE DRAWINGS

FIG. 1 is a block diagram of system principle of the invention.

FIG. 2 is a flow chart of operation principle of the invention.

FIG. 3 is a schematic diagram of TSI-SDS-TSI switching method applied in the invention.

FIG. 4 is a flow chart of switching procedure of the invention.

FIG. 5 is a flow chart of time-slot configuration of the invention.

### DETAILED DESCRIPTION OF THE INVENTION

### Embodiments

Core idea of the invention: The signal receiving/transmitting units pack the multiple composite signals acquired from different front end sections and transmit them to the serial/parallel modular converter, the serial/parallel modular converter converts them into parallel signals, the parallel signals are decomposed by the switching interface module, multiple simple info signals and associated status information are obtained, and the multiple simple info signals are TSI-SDS-TSI switched; when CPU system unit receives the status information, corresponding control signals and information are generated; the simple info signals which are TSI-SDS-TSI switched are compounded with the control information and are converted into serial signals which will be unpacked and output by the signal receiving/transmitting units.

The invention shall be further described in the following paragraphs with the aid of the attached figures and specific implementation examples in order to set forth the idea and objective of the invention.

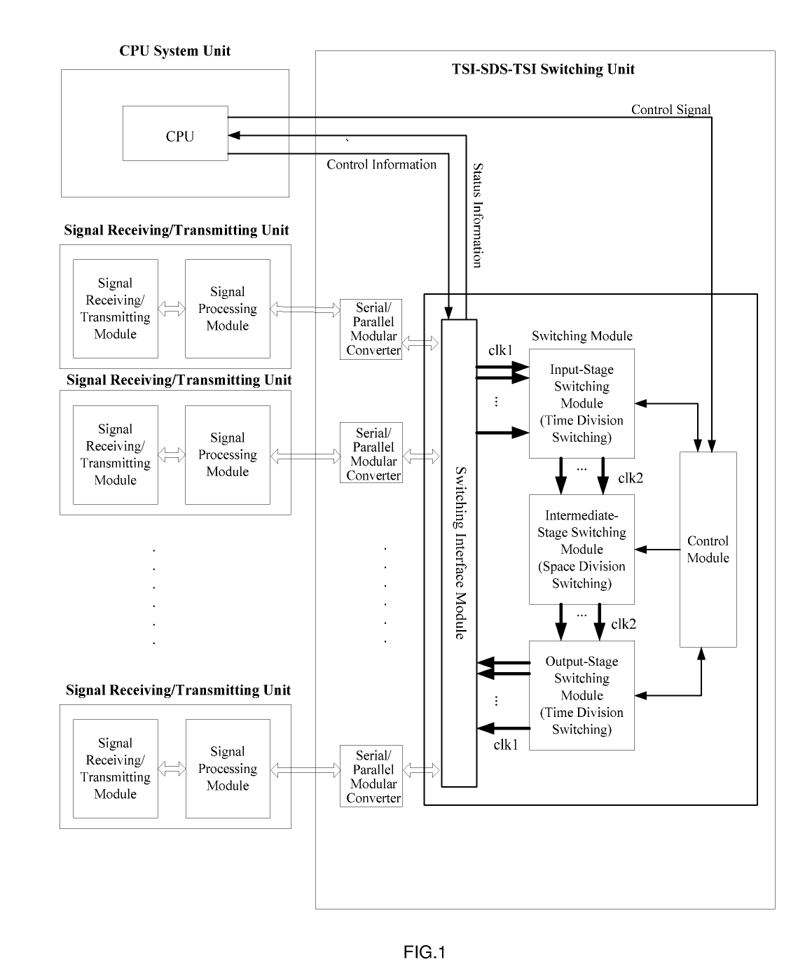

As shown in FIG. 1, the invention provides a type of multi-signal switching system for surveillance systems, the multi-signal switching system is mainly composed of a CPU system unit, signal receiving/transmitting units, and a TSI-SDS-TSI switching unit; of which, the signal receiving/transmitting unit is mainly composed of a signal receiving/transmitting module and a signal processing module; the said signal receiving/transmitting module is used to receive the acquired multi-signals and transmits the signals that had experienced the TSI-SDS-TSI switching; while, the signal processing module is used to pack and transmit the multi-signals and unpack the signals that had experienced the TSI-SDS-TSI switching; the signal receiving/transmitting module here is capable of both signal receiving and signal outputting; the multiple external composite signal it receives mainly include the video signals acquired by front-end equipment like camera, the audio signals acquired by microphone, and other data signals, electric signals, optic signals, and alarm signal etc.; all these signals acquired by the front-end equipment are transmitted to the signal receiving/transmitting module of the signal receiving/transmitting units, packed and transmitted by the signal processing modules.

The TSI-SDS-TSI switching unit is mainly composed of a serial/parallel modular converter, an switching interface module, a switching module, and a control module; the said serial/parallel modular converter is used to decompose the multi-signals that come from the signal receiving/transmitting units and had been processed by the signal processing module, obtain parallel signals and transmit the parallel signals to the switching interface module; while, the switching interface module is used to decompose the above-mentioned parallel signals into multiple simple info signals and corresponding status information; here, the switching interface module mainly decomposed the parallel signals into video, audio, alarm, and other simple info signals, and has the status information decomposed out. The status information here refers to some front-end equipment information corresponding to the video and audio information, such as the in-serve behavior, failure information, and position information of the said front-end equipment.

The multiple simple info signals output by the switching interface module are directly input into the input-stage switching module, intermediate-stage switching module, and the output-stage switching module orderly; time division switching is conducted in the input-stage switching module first, here the input-stage switching module refers to the clock clk1; when time division switching is over, the signals are input into the intermediate-stage switching module to experience space division switching, here the intermediate-stage switching module refers to the clock clk2, and the frequency of clk2 is twice that of the clk1; when the space division switching is over, the signals are input into the output-stage switching module for processing and is then output to the switching interface module.

Where, the status information is transmitted to the CPU system unit. The CPU system analyzes the status information and transmits corresponding control signals to the control module. The control module conducts time-slot configuration of the switching module. The switching module conduct TSI-SDS-TSI switching of the input signals and outputs multiple simple info signal. Meanwhile, the CPU system unit outputs control information to the exchange interface module. The control information is compounded with the above-mentioned multiple simple info signals, and then the compounded signals are output by the signal receiving/transmitting units.

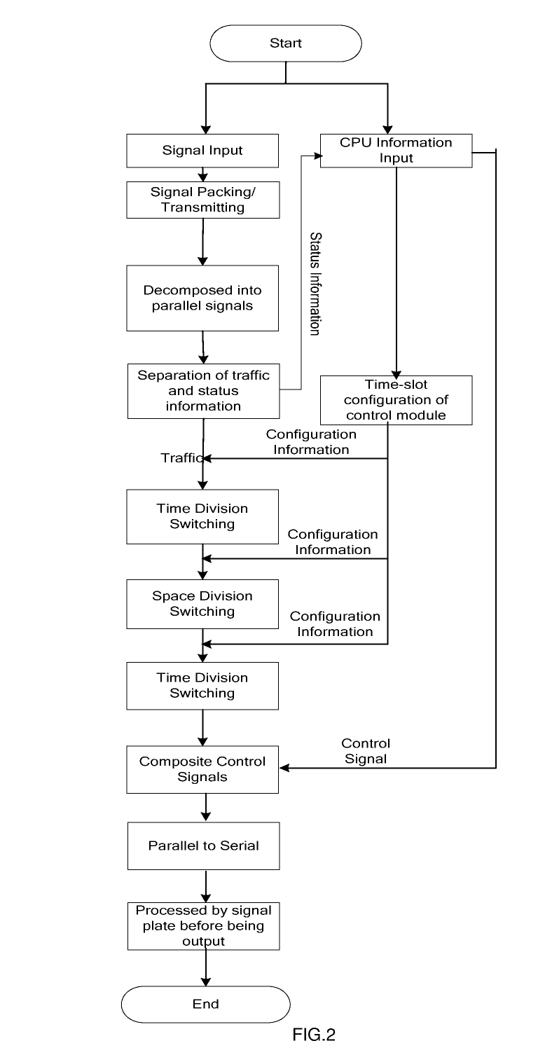

The system is described in the above paragraphs, and the operation principle of the invention shall be further described in the following with reference to FIG. 2.

FIG. 2 is a flow chart of operation principle of the invention. The invention also provides a type of multi-signal switching method for surveillance systems, and its specific operation principle is given below:

Firstly, the signal receiving/transmitting units pack the acquired multi-signals and transmits them to the TSI-SDS-TSI switching unit;

The signal receiving/transmitting unit here is composed a signal receiving/transmitting module and a signal processing module. T the front-end equipment in the surveillance system transmit all the acquired audio, video, alarm, photoelectric, and data signals to the signal receiving/transmitting modules. The signal receiving/transmitting module utilizes the signal processing module to pack and transmit these signals to the TSI-SDS-TSI switching unit.

Then, the TSI-SDS-TSI switching unit conducts decomposition of the received multi-signals, and conduct TSI-SDS-TSI switching of the decomposed information.

Where, the TSI-SDS-TSI switching unit is mainly composed of a serial/parallel modular converter, a switching interface module, a switching module, and a control module; Signals come from the signal receiving/transmitting units are converted to parallel signals by the serial/parallel modular converter first, and these parallel signals are transmitted to the switching interface module; the switching interface module decomposes the received parallel signals into multiple simple info signals and corresponding status information; The multiple simple info signals are then transmitted to the input-stage switching module for time division switching, and the corresponding status information is transmitted to the CPU system unit. The CPU system unit analyzes the status information, and generates control signal to the control module for configuration of the time slots.

The control module configure time-slot for the input-stage switching module, the intermediate-stage switching module, and the output-stage switching module respectively; meanwhile, the input-stage switching module, intermediate-stage switching module, and output-stage switching module conduct TSI-SDS-TSI switching of the simple info signals according to the configuration, and the process of time-slot configuration is independent of the switching process.

Finally, the switched simple info signals are compounded with the control information produced by the CPU system unit to generate parallel composite signals; the parallel composite signals are converted by the serial/parallel modular converter into serial signals which are then unpacked by the signal processing module of the signal receiving/transmitting units and output by the signal receiving/transmitting module.

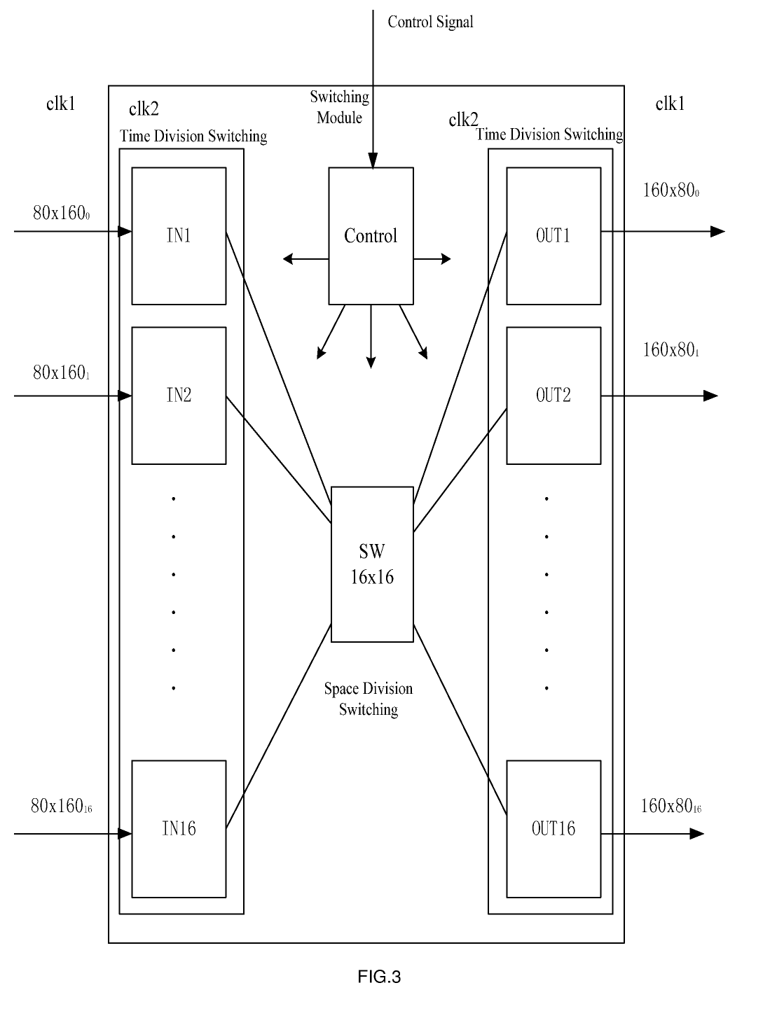

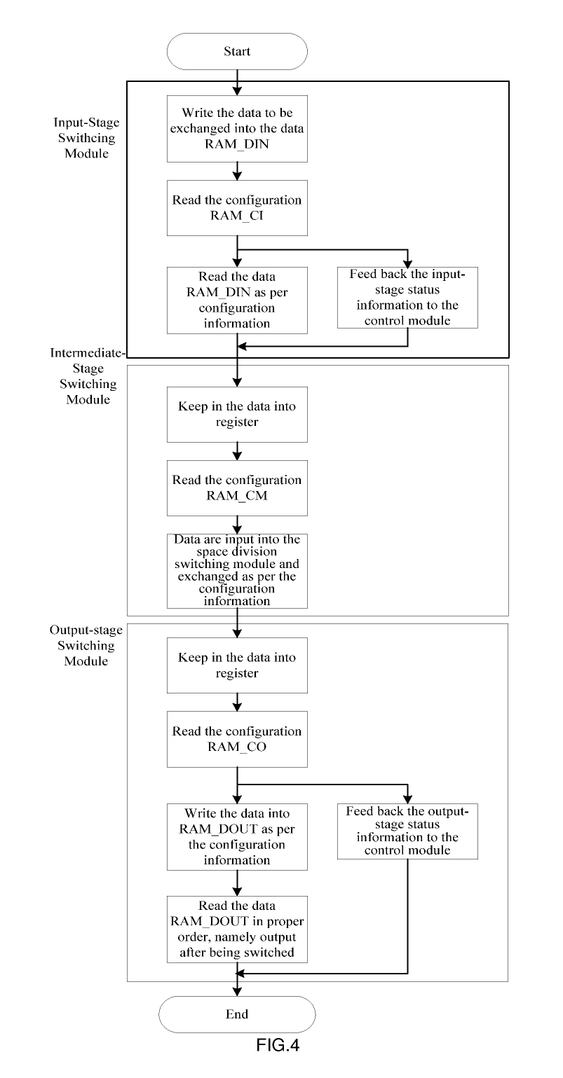

The principle of the invention is mentioned above. The switching module applied in the invention employs TSI-SDS-TSI switching method, and the method will be described in the following with reference to FIG. 3 and FIG. 4.

As shown in FIG. 3 and FIG. 4, the input-stage switching module here employs time division switching method. Since there are 16 signal receiving/transmitting units, 16 input channels are needed, therefore, 16 corresponding sub-switching modules IN1˜IN16 inside the input-stage switching module are requisite. The sub-switching module's input channel refers to the clock CLK1. Each sub-switching module's input channel is divided into 80 time slots, so the total amount of input time-slot is 16×80=1280. The sub-switching module's output refers to the clock CLK2, while the frequency of CLK2 is twice that of CLK1, thus the sub-switching module's output channel is divided into 160 time slots. Therefore, each input end of sub-switching module has 80 input time slots while each output end has 160 output time slots. Every sub-switching module accomplishes a time division switching process of 80×160. The switching process of the input-stage switching module is actualized according to the control module's time-slot configuration which is implemented by configuring the RAMs embedded in FPGA. The occupation of logic resource can be greatly reduced with the usage of time slot interpolation technology for the parallel high-speed data bus inside the FPGA and the utilization of the embedded RAMs during the info signal switching process. The steps of this stage are given as follows: Write the data into the data buffer ram RAM_DIN. Read the time-slot configuration information from the configuration storing ram RAM_Cl of the input-stage switching module. Read the data from the RAM_DIN in accordance with the configuration information. Send the data to the intermediate-stage switching module and feed back the status information of the input-stage switching module to the control module.

Since the magnitude of intermediate-stage switching module is rather slight, it is appropriate to employ the space division switching method. A 16×16 space division switcher is implemented in the intermediate-stage switching module. Because this module refers to clock CLK2, each of its input and output channel is divided into 160 time slots. Space-division switching with 16 inputs and 16 outputs takes place at each of the 160 time slots. The switching process of the intermediate-stage switching module also requires the control module's time-slot configuration which is implemented by configuring the embedded RAMs. The steps of this stage are given as follows: Keep the data in registers. Read the time-slot configuration information from the configuration storing ram RAM_CM of the intermediate-stage switching module. Switch the data through space division switcher in accordance with the configuration information, and send the output data to the output-stage switching module.

The output-stage switching module employs the time division switching method. Similarly, 16 input channels are needed since there are 16 signal receiving/transmitting units, therefore, 16 corresponding sub-switching modules OUT1˜OUT16 inside the output-stage switching module are requisite. The sub-switching module's output channel refers to the clock CLK1. Each sub-switching module's output channel is divided into 80 time slots, and so the total amount of output time-slot is 16×80=1280. The sub-switching module's input refers to the clock CLK2, thus the sub-switching module's input channel is divided into 160 time slots. In other words, each input end of sub-switching module has 160 input time slots while each output end has 80 output time slots, therefore, each sub-switching module accomplishes a time division switching process of 160×80, which is quite opposite to the input-stage switching module. The switching process of the output-stage switching module is also actualized by the control module's time-slot configuration which is implemented by configuring the RAMs embedded in FPGA. Similar to the input-stage exchange module, the occupation of logic resource can be greatly reduced with the usage of time slot interpolation technology for the parallel high-speed data bus inside the FPGA and the utilization of the embedded RAMs during the info signal switching process. The steps of this stage are given as follows: Keep the data in registers. Read the time-slot configuration information from the configuration storing ram RAM_CO of the output-stage switching module. Write the data into the RAM_DOUT in accordance with the configuration information and feed back the status information of the output-stage switching module to the control module. Read data in turn from RAM_DOUT and send the output data to the switching interface module.

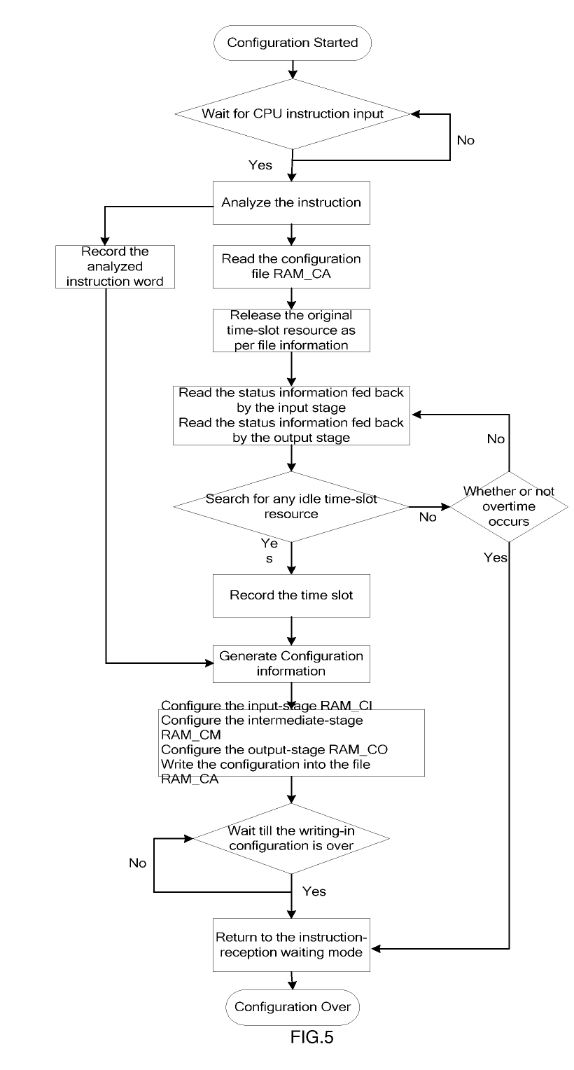

FIG. 5 shows a flow chart of time-slot configuration process of this invention. The time-slot configuration process and switching process are independently. Once the control module finishes configuring the input-stage switching module, intermediate-stage switching module, and output-stage switching module, the 3-stage switching modules can run independently as per the configured contents, and the data can actualized switching of 1280×1280 traffics. Each input/output channel corresponds to a signal receiving/transmitting unit which can load 1 Gigabit effective data. 16 signal receiving/transmitting units can load 16 Gigabit data. In a word, the entire switching module achieves a large traffic volume of 16 G×16 G within one FPGA. The process of data transfer from switching module's input ports to output ports takes only several clock cycles and the data delay is approximately scale of nanoseconds.

The detailed time-slot configuration process is given as follows: Judge CPU switching instruction has arrived or not. If not, return and still waiting. Else, analyze the instruction and record the analyzed instruction word. Read the configuration storing RAM_CA of control module, release the particular time-slot according to the configuration information. Read the status information of the input/output switching module. Is there any available idle time-slot resource? If not, return and re-read the status information of the input/output-stage until available time slot is found or overtime occurs. If overtime occurred process return back to the start status, else, continue. Record the available time slot and generate configuration information based on the available time slot and instruction word. Then configure the configuration storing ram RAM_Cl of input-stage module, RAM_CM of intermediate-stage module, RAM_CO of output-stage module, and RAM_CA of the control module. When configuration writing-in is over, exit and return to the start status and waiting for new switching instruction.

Output the switched info signal to the switching interface module, compound control signals or other info signal to the idle time slots, and convert them into serial signals with the aid of the Serdes (parallel/serial and serial/parallel converter) of the serial/parallel modular converter and output the serial signals to the signal receiving/transmitting units. the Serdes of the signal receiving/transmitting units unpacks the serial signals into parallel signals, and the FPGA of signal receiving/transmitting units outputs the signals through the signal receiving/transmitting module in accordance with relevant protocols.

It can be observed from the above description that this invention can solve a series of problems such as too many access equipment, complicated network, inefficient usage of bandwidth, and high operation costs of the present technology by designing a set of simple effective system and method. In the invention, the equipment such as the original audio matrix switchover system, video matrix switchover system, and alarm device etc. are substituted by a TSI-SDS-TSI switching unit, the amount of accessed system equipment is reduced, the network structure is optimized, and the operation cost is cut down.

In the above paragraphs, a type of multiform-signal switching system and method for security surveillance systems are described in detail. Specific examples are given in the text to set forth the principle and implementation of the invention, and the explanations of the above-mentioned implementation examples are only intended to aid people to understand the method and core ideas of the invention. Meanwhile, ordinary technicians specialized in this field may change the specific implementation mode and application range in accordance with the idea of the invention. All in a word, contents of the specification shall not be considered as restriction on the invention.

I claim:

1. A system for multi-signal switching system in security surveillance system, comprising a CPU system unit, and its characteristics also include:
The signal receiving/transmitting units, used to receive the acquired multi-signals, pack and transmit the multi-signals to the TSI-SDS-TSI switching unit;
A TSI-SDS-TSI switching unit, used to decompose the multi-signals come from the signal receiving/transmitting unit, and conduct TSI-SDS-TSI switching of the decomposed signals by CPU unit.

2. The switching system as described in claim 1, characterized in that the said TSI-SDS-TSI switching unit comprises:
A serial/parallel modular converter, used to convert the multi-signals come form signal receiving/transmitting units into parallel signals and transmit them to the switching interface module;
A switching interface module, used to decompose the above-mentioned parallel signals into multiple simple info signals and corresponding status information;
A switching module, used to receive the multiple simple info signals come from the switching interface module, and conduct TSI-SDS-TSI switching of the info signals;
A control module, used to receive the control signals of CPU system unit, and configure the time-slot for the switching module as per the said control signals.

3. The switching system as described in claim 1 or claim 2, characterized in that the said switching interface module transmits the decomposed status information to the CPU system unit, and the CPU system unit outputs the control signals to the control module according to the said status information.

4. The switching system as described in claim 2, characterized in that the said switching module includes an input-stage switching module, an intermediate-stage switching module, and an output-stage switching module, and the said input-stage switching module, intermediate-stage switching module, and output-stage switching module conduct multiple info signals switching respectively according to the time-slot configuration of the control module.

5. The switching system as described in claim 1, characterized in that the said signal receiving/transmitting unit includes a signal receiving/transmitting module and a signal processing module, the said signal processing unit may be also used to receive the signals that experienced the TSI-SDS-TSI switching, and unpack and output the information through the signal receiving/transmitting module.

6. A method for multi-signal switching in a security surveillance system, characterized in that the following steps are included:
A. The signal receiving/transmitting units pack the acquired multi-signals and transmits them to the TSI-SDS-TSI switching unit;
B. The TSI-SDS-TSI switching unit conducts decomposition of the received multi-signals, and conduct TSI-SDS-TSI switching of the decomposed information.

7. The switching method as described in claim 6, characterized in that the TSI-SDS-TSI switching unit is composed of a serial/parallel modular converter, a switching interface module, a switching module, and a control module, and the step B includes the following steps in detail:
b1. A serial/parallel modular converter decomposes the acquired multi-signals into parallel signals and transmits them to the switching interface module;
b2. A switching interface module decomposes the received parallel signals to generate multiple simple info signals and corresponding status information;
b3. The switching module conducts TSI-SDS-TSI switching of multiple simple info signals as per the time-slot configuration.

8. The switching method as described in claim 7, characterized in that Step b2 still include the following substeps:
1) The switching interface module transmits the decomposed status information to the CPU system unit;
2) The CPU system unit transmits control signals to the control module as per the above-mentioned status information;
3) The control module conducts time-slot configuration of the switching module as per the control signals.

9. The switching method as described in claim 6, characterized in that the following steps shall be performed next to Step B:
C. Compound the signals that had experienced the TSI-SDS-TSI switching with the control information transmitted by the CPU system unit to generate composite signals.

10. The switching method as described in claim 9, characterized in that the following steps shall be performed next to Step C:
D. Utilize the serial/parallel modular converter to convert the compounded signals into serial signals, transmit the signals to the signal receiving/transmitting unit, and the signals will be output after being unpacked by the signal receiving/transmitting unit.
